(19) United States
(12) Patent Application Publication
(10) Pub. No.: US 2010/0293618 A1
(43) Pub. Date: Nov. 18, 2010

(54) RUNTIME ANALYSIS OF SOFTWARE PRIVACY ISSUES

(75) Inventors: Ivan Medvedev, Bellevue, WA (US); Clyde R. Roberts, IV, Kenmore, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/464,589

(22) Filed: May 12, 2009

(51) Int. Cl. G06F 21/00

(52) U.S. Cl. 726/26

(57) ABSTRACT

An application may watch to see if information passes a defined trust barrier. If defined information passes a defined trust barrier, an alert may be issued. The alert may include informing a developer of the specific code section that triggered the alert.

### BACKGROUND

This Background is intended to provide the basic context of this patent application and it is not intended to describe a specific problem to be solved.

Detecting relevant data and pinpointing the source of data transmission across electronic trust boundaries may be difficult given traffic and operations generated by basic systems such as the operating system and network protocol data transmissions. Trying to pinpoint the application of code section that caused the breach of the trust boundary also has been a challenge.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of reviewing electronic communication of a computing device to determine if unwanted data transfers occurred such as a transfer of information of interest, such as personally identifiable information, of a user that passes a defined trust boundary is disclosed. The method captures communication from a computing device, stores the communication in a memory, captures stack traces related to the communication and selects review communications. The review communications may be the communication that satisfies a trust boundary condition. The symbols for the stack traces in computer executable code related to the review communications may be resolved and the review communications and the symbols may be stored in a memory. The review communications may be searched for information of interest. Searching for information may entail selecting the review communications that satisfy at least one information heuristic condition. The heuristic may be based on the data payload or may be based on the source and destination of the data packet. If the information is found or if the transfer was made without consent, an alert may be communicated that the information has been communicated beyond the defined trust barrier.

### BRIEF DESCRIPTION OF THE DRAWINGS

FIG. 1 is an illustration of a computing device;

FIG. 2 is an illustration of a method of method reviewing electronic communication of a computing device to determine if a user defined trust boundary has been breached;

FIG. 3 is an illustration of a single computing device scenario network traffic implementation;

FIG. 4 is an illustration of a virtual machine hosting computing device scenario network traffic implementation; and

FIG. 5 is an illustration of a results output network traffic implementation.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

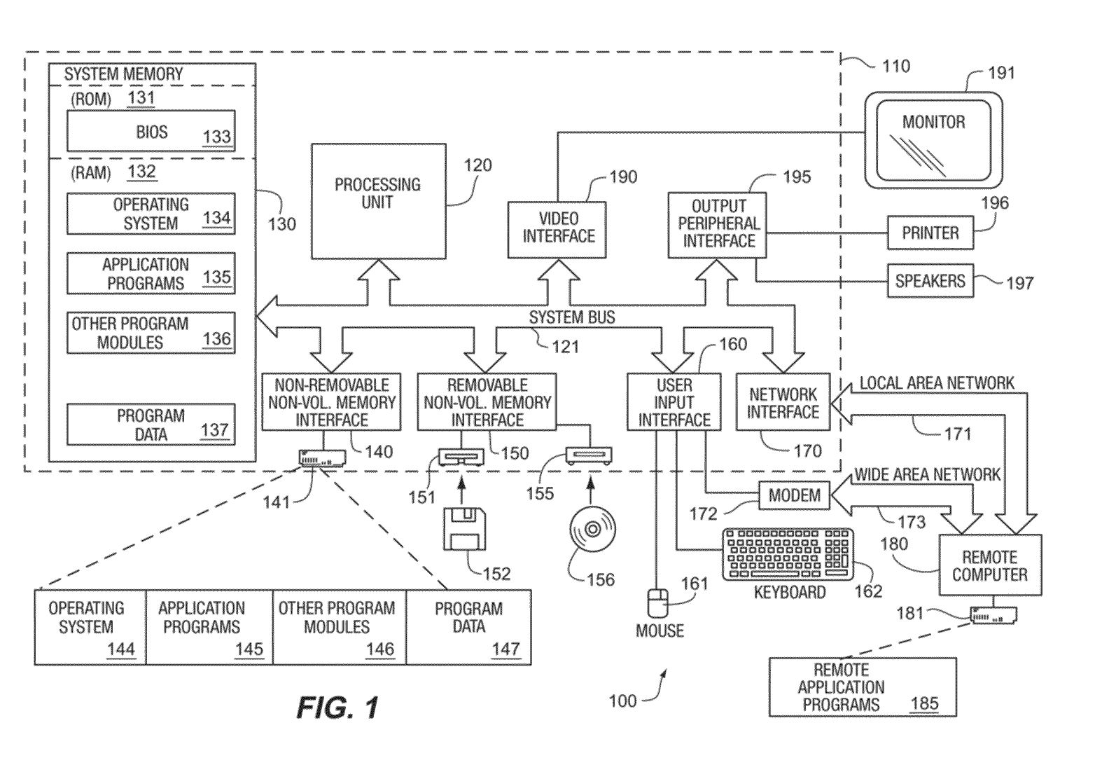

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

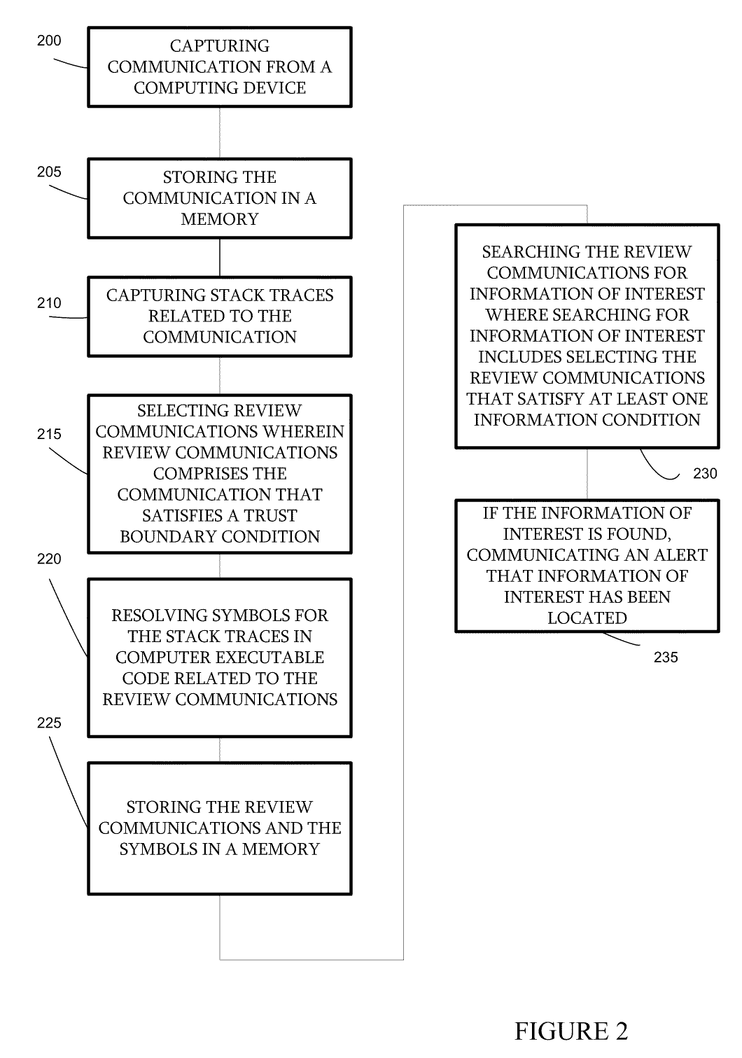

FIG. 2 may illustrate a method reviewing electronic communication of a computing device to determine if a user defined trust boundary has been breached. A trust boundary may be a logical space where users have a specified amount of control over their personal data. As data cross the trust boundary, the control of the data may change in terms of who can access the data and what users can do with it. Privacy issues may arise when software transmits data across the trust boundary in a manner counter to the user's expectation, which may upset users and result in unwanted consequences. In addition, the transfer may be a breach of contract, breach of an end user agreement or a breach of the privacy disclosure.

Detecting relevant data and pinpointing the source of data transmission across electronic trust boundaries may be difficult given traffic and operations generated by basic systems such as the operating system and network protocol data transmissions. Trying to pinpoint the application of code section that caused the breach of the trust boundary also has been a challenge.

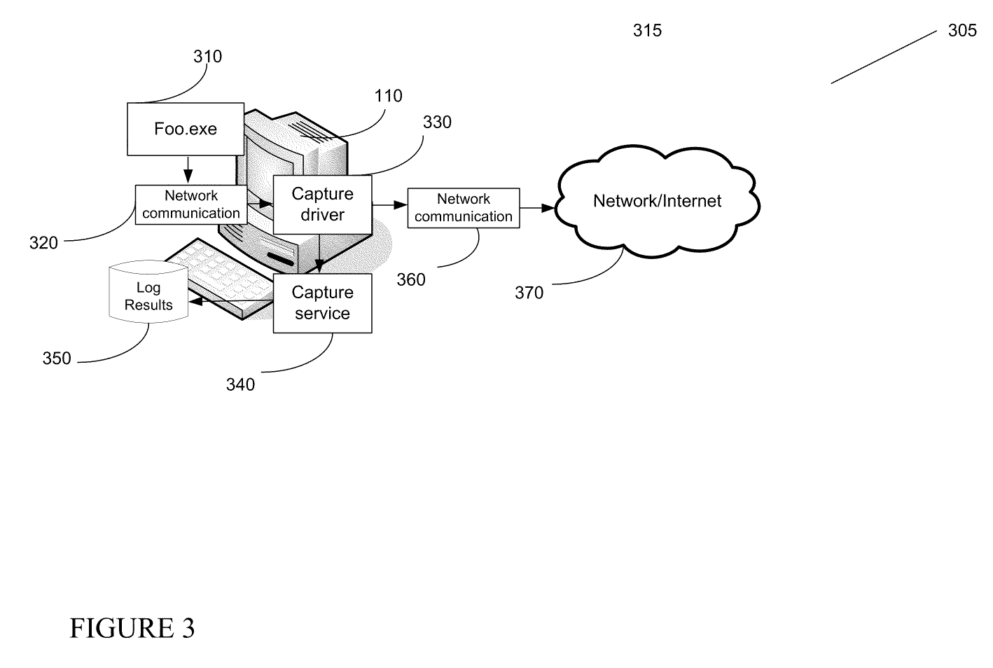

At block 200, communication may be captured from a computing device 110. Referring to FIG. 3, the computing device may be a computing device such as the computing device 110 described in FIG. 1. The communication may be captured in a variety of ways. In one embodiment, an application 310 (Foo.exe) is operating on the computing device 110. The application 310 may use network communication 320 to communicate data which may be captured by the capture driver 330. The capture driver 330 may capture all network communications 320 or just network communications that appear to be of interest. A capture service 340 may receive the network communications 320 from the capture driver 330 and store the results in a log 350. The results may be reviewed prior to be stored or after they are stored in the log 350. The network communication 360 may then leave the computing device 110 and travel to an outside location 370, such as a network or the Internet.

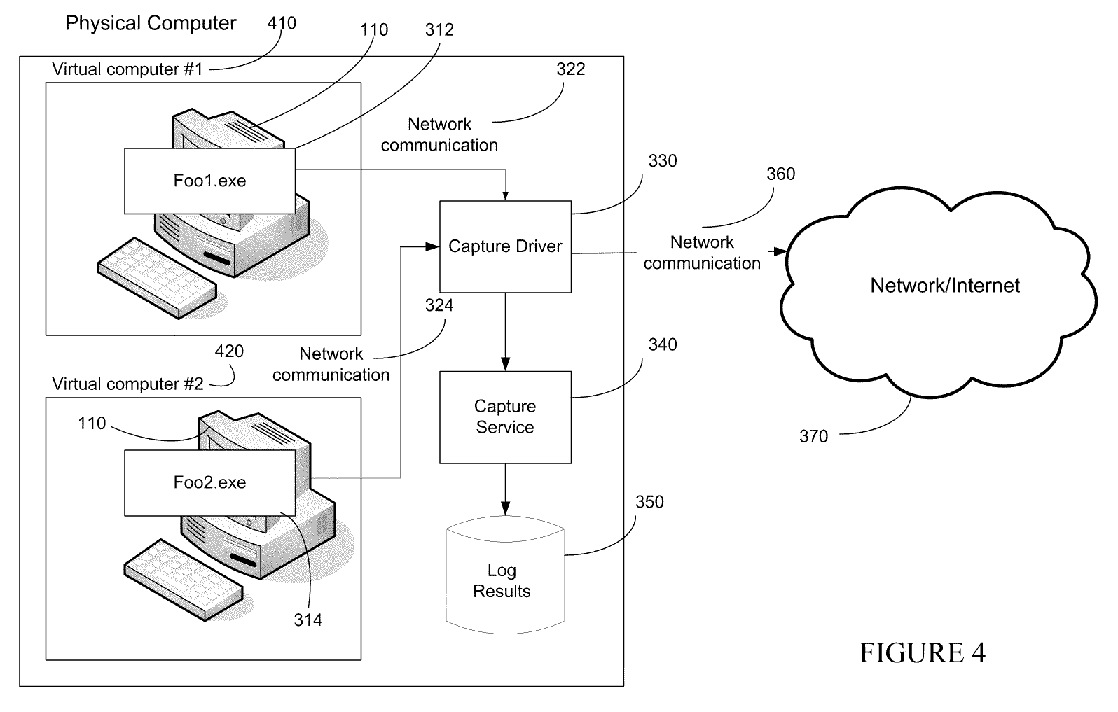

FIG. 4 may illustrate another example where two virtual machines or virtual computers 410 420 are operating on the same computing device 110. The first virtual computer 410 may execute a first application 312 (Foo1.exe) and may have its own network communication 322. The second virtual computer 420 may execute a second application 314 (Foo2.exe) and may have its own network communication 324. Both the network communication 322 from the first virtual computer 410 and second virtual computer 420 may be captured by the capture drive 330, reported to the capture service 340 and stored in the log 350.

Referring again to FIG. 2, at block 205, the communication 320 may be stored in a memory such as in the log 350. As explainer previously, the communication 320 may be captured in any logical manner such as using a capture driver 330 to feed data to a capture service 340 and storing the data in a log 350. Of course, other manners of capturing the data are possible and are contemplated.

At block 210, stack traces related to the communication may be captured. The stack traces may be kernel stack traces or user mode stack traces. In either case, a picture of the stack may be stored such that it may be later reviewed (or resolved) to determine in the computer executable code the cause of the breach of the trust boundary.

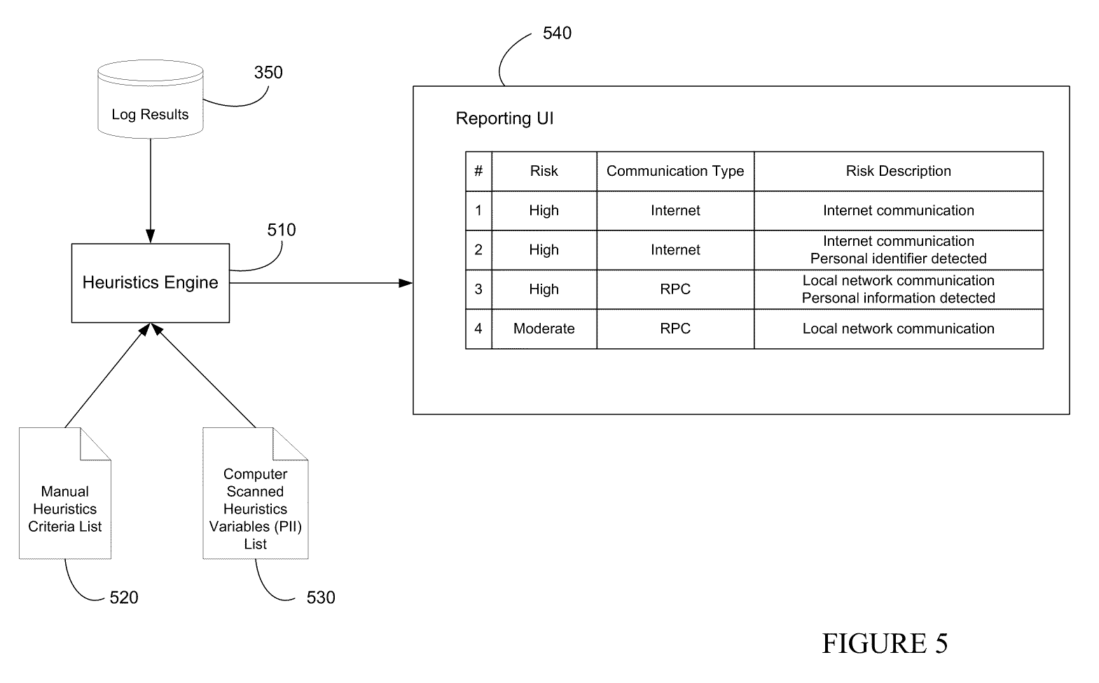

At block 215, review communications may be selected. Review communications may be the communication 320 that satisfies a trust boundary condition. The review may be part of the capture service 340 or may be a separate analysis of the log 350 as will be described in relation to FIG. 5.

The trust boundary condition may be any communication 320 that passes over a boundary set by a user. Examples of a trust boundary include, but are not limited to, communicating to a memory, communicating to a local network, communicating to an outside network and communicating to a peripheral device. The source of the trust boundary may be a separate application, may be set by a user, may be set according to a remote authority or may be a combination of all the sources. Communicating to a memory may sound harmless, but if the computing device 110 is a device 110 used by many users, even this data may pass a trust boundary.

At block 220, symbols for the stack traces may be resolved or mapped to computer executable code related to the review communications. In this way, the cause of the violation of the trust boundary may be mapped to a specific code section. Once the code section is known, it may be corrected, reviewed, adjusted, modified, etc.

At block 225, the review communications and the symbols may be stored in a memory such as the log 350. The log 350 may be stored locally or may be stored remotely, such as at an IT location. The log may be stored in a logical manner that may be easily and quickly searched, such as in a database.

At block 230, the review communications may be searched for information of interest such as personally identifiable information. This information may be determined by selecting the review communications that satisfy at least one information condition heuristic or simply the fact that data was transferred. An information condition a particular user does not desire to be available to others may be set as a condition. For example, information conditions that may be set include data that is communicated outside the computing device, any data that is communicated to a specific website, any data that contains a user name, any data the matches a pattern for other personal data, any unauthorized communication, phoning home type behavior, etc. The communication may or may not contain personal information. The communication may be noticed by reviewing the sending and receiving addresses of the packets being communicated or by simply reviewing the payload of the packets.

In some embodiments, the information condition is preset. In other embodiments, the information condition is set by a user. In yet other embodiments, information conditions are retrieved or pushed from a remote source. Of course, what is an information condition is personal and may vary by application, user, situation, embodiment, etc. The method may be intelligent and may learn from user inputs what the user considers personal. For example, if a home address is marked as personal, a home phone number is likely personal.

The determination of what is an information of interest condition are based on heuristics. FIG. 5 may illustrate a sample heuristics engine 510 that uses manually entered criteria 520 and computer scanned heuristics 530 to determine if a pattern of personally identifiable information has been met. Some patterns for information of interest may include personally identifiable information such as the pattern of a credit card, pattern of a social security number, the pattern of a telephone number and the pattern of an email address. In addition, communications that are sent with or without authorization to certain addresses or from certain addresses (phone home type behavior) may satisfy criteria 520 of heuristics 530.

Again, the engine may need to be tuned to the situation. For example, some salesmen go to great lengths to get their phone number and email address into users' hands. On the other hand, teachers may go to great lengths to keep home phone numbers and email addresses out of the reach of students. The situation will likely drive what would satisfy the information of interest condition, and the condition may be created and stored for each individual user.

At block 235, if the information of interest, is detected, an alert 540 may be communicated that information of interest (or information that satisfies the information of interest condition) has been located. The alert 540 may be in virtually an form that triggers a sensory response in a user.

In some embodiments, the alert 540 may include the information of interest that passed the trust barrier. In other embodiments such as when the code is being tested by a developer or is part of a development application, the alert 540 may include the origin in of the network traffic in the computer executable code.

If the alert 540 is part of a development application, and if an alert 540 is generated, the application execution may be stopped and the alert 540 may be presented to the developer. The alert 540 may include the code section at fault which may be determined from the stack traces and symbols therein.

The alert 540 also may rank the risk of the information being passed and how it is being passed. Some breaches of the trust boundary may be classified as high, medium or low. The classification may be set by the application, by a user or by a remote application. Based on the alert, the developer may attempt to adjust the computer executable code to avoid or mitigate the violation of the trust boundary.

As a result of the method, increased flexibility in describing data that may be personally identifiable may be achieved. In addition, additional flexibility may be obtained through defining the personal trust boundary. By allowing the definition of what is personally identifiable information and what is a persona trust boundary to change and be varied, virtually any situation may be handled.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of reviewing electronic communication of a computing device to determine if a user defined trust boundary has been breached comprising:
capturing a communication from the computing device;
storing the communication in a memory;
capturing stack traces related to the communication;
selecting review communications wherein review communications comprises the communication that satisfies a trust boundary condition;
resolving symbols for the stack traces in computer executable code related to the review communications;
storing the review communications and the symbols in a memory;
searching the review communications for information of interest wherein searching for the information of interest comprises selecting the review communications that satisfy at least one information condition; and
if the information of interest is found, communicating an alert that the information of interest has been located;

2. The method of claim 1, wherein the alert comprises the information of interest.

3. The method of claim 1, wherein the alert comprises the origin in the computer executable code of a cause of the alert.

4. The method of claim 1, wherein the stack traces are at least one of kernel stack traces or user mode stack traces.

5. The method of claim 1, wherein the trust boundary condition is one selected from a group comprising:
communicating to a memory;
communicating to a local network;
communicating to an outside network; and
communicating to a peripheral device.

6. The method claim 1, wherein the trust boundary is set by a user.

7. The method of claim 1, wherein the information condition is satisfied when at least one from a group comprising:
any data is communicated outside the computing device;
any data is communicated to a specific website;
any data that contains a user name;
any data that matches a pattern for other personal data.

8. The method of claim 7, wherein the pattern for other personal data comprises at least one selected from the group comprising:
the pattern of a credit card;
the pattern of a social security number;
the pattern of a telephone number; and
the pattern of an email address.

9. The method of claim 1, wherein a plurality of computing applications within the computing device are monitored.

10. The method of claim 1, wherein the method is part of a development application.

11. The method of claim 10, wherein if the alert is generated, stopping application execution and presented the alert to a developer using the development application.

12. The method of claim 11, wherein the alert comprises a code location that caused the alert.

13. The method of claim 1, further comprising:
searching the review communication for an unauthorized communication; and
if the unauthorized communication is detected, communicating the alert that the unauthorized communication has been located.

14. A computer storage medium comprising computer executable instructions for configuring a processor to execute a method of reviewing electronic communication of a computing device to determine if a user defined trust boundary has been breached, the computer executable instructions comprising computer executable instructions for:
capturing a communication from the computing device;
storing the communication in a memory;
capturing stack traces related to the communication;
selecting review communications wherein review communications comprises the communication that satisfies a trust boundary condition;
resolving symbols for the stack traces in computer executable code related to the review communications;
storing the review communications and the symbols in a memory;
searching the review communications for information of interest wherein searching for the information of interest comprises selecting the review communications that satisfy at least one information condition; and
if the information of interest is found, communicating an alert that the information of interest has been located.

15. The computer storage medium of claim 14, wherein the trust boundary condition is one selected from a group comprising:
communicating to a memory;
communicating to a local network;
communicating to an outside network; and
communicating to a peripheral device and
wherein the information condition is satisfied when at least one from a group comprising:
any data is communicated outside the computing device;
any data is communicated to a specific website;
any data that contains a user name;
any data that matches a pattern for other personal data; and
wherein the pattern for other personal data comprises at least one selected from the group comprising:
the pattern of a credit card;
the pattern of a social security number;
the pattern of a telephone number; and
the pattern of an email address.

16. The computer storage medium of claim 14, wherein:
the method is part of a development application;
if the alert is generated, stopping application execution and presented the alert to a developer using the development application; and
the alert comprises a code location that caused the alert.

17. A computer system comprising a processor physically configured according to computer executable instructions, a memory for maintaining the computer executable instructions and an input/output circuit, the computer executable instructions comprising instructions for a method of reviewing electronic communication of a computing device to determine if a user defined trust boundary has been breached, the computer executable instructions comprising computer executable instructions for:
capturing a communication from the computing device;
storing the communication in a memory;
capturing stack traces related to the communication;
selecting review communications wherein review communications comprises the communication that satisfies a trust boundary condition;
resolving symbols for the stack traces in computer executable code related to the review communications;
storing the review communications and the symbols in a memory;
searching the review communications for information of interest wherein searching for the information of interest comprises selecting the review communications that satisfy at least one information condition; and
if the information of interest is found, communicating an alert that the information of interest has been located.

18. The computer system of claim 17, wherein the trust boundary condition is one selected from a group comprising:
communicating to a memory;
communicating to a local network;
communicating to an outside network; and
communicating to a peripheral device and
wherein the information condition is satisfied when at least one from a group comprising:
any data is communicated outside the computing device;
any data is communicated to a specific website;
any data that contains a user name;
any data that matches a pattern for other personal data; and
wherein the pattern for other personal data comprises at least one selected from the group comprising:
the pattern of a credit card;
the pattern of a social security number;
the pattern of a telephone number; and
the pattern of an email address.

19. The computer system of claim 17, wherein:
the method is part of a development application;
if the alert is generated, stopping application execution and presented the alert to a developer using the development application; and
the alert comprises a code location that caused the alert.

20. The computer system of claim 17, further comprising computer executable code for:
searching the review communication for an unauthorized communication; and
if the unauthorized communication is detected, communicating the alert that the unauthorized communication has been located.
